(19) United States
(12) Patent Application Publication
(10) Pub. No.: US 2008/0307961 A1
(43) Pub. Date: Dec. 18, 2008

(54) CENTRIFUGAL SEPARATION OF RARE GASES

(76) Inventors: Robert J. Howard, Clifton, VA (US); John W. Rapp, Manassas, VA (US)

Correspondence Address: LOCKHEED MARTIN NE&SS MANASSAS, 9500 GODWIN DRIVE, M.S. 400/043, MANASSAS, VA, 20110, US

(21) Appl. No.: 12/139,221

(22) Filed: Jun. 13, 2008

Related U.S. Application Data
(60) Provisional application No. 60/943,749, filed on Jun. 13, 2007.

(51) Int. Cl. B01D 45/12; B01D 45/16; B01D 45/08

(52) U.S. Cl. 95/35; 55/461; 55/434.4; 55/456

(57) ABSTRACT

A system and process to extract one or more rare gases from a feed gas using a centrifuge.

### RELATED APPLICATION

This application claims the benefit of the filing date of U.S. Provisional Patent Application Ser. No. 60/943,749 filed Jun. 13, 2007, which application is incorporated herein in its entirety.

### TECHNICAL FIELD

The present disclosure relates to the separation and extraction of rare gases from a feed gas.

### BACKGROUND

Rare gases, such as xenon, krypton, neon, and argon are present in normal atmospheric air and other feed gases in very small quantities, and they are difficult to extract. Such rare gases are usually extracted as a byproduct of air liquefaction. The air or feed gas can be liquefied and then the rare gases extracted using a fractional distillation process. Industry would benefit from a new process to extract rare gases from atmospheric air or other feed gas.

### BRIEF DESCRIPTION OF THE DRAWINGS

FIG. 1 is a block diagram illustrating an embodiment of an Ocean Thermal Energy Conversion (OTEC) and noble gas extraction system.

FIG. 2 illustrates a block diagram of an example embodiment of a three-stage centrifuge for separating and extracting rare gases from a feed gas.

FIG. 3 illustrates a longitudinal cross sectional view of a centrifuge that can be used to separate and extract rare gases.

FIGS. 4A and 4B illustrate traverse cross sectional views of a centrifuge that can be used to separate and extract rare gases.

FIG. 5 illustrates a heat exchanger that can be used in conjunction with a centrifuge to separate and extract rare gases.

### SUMMARY

A system and process comprise one or more centrifuges that are configured to receive a feed gas and extract one or more rare gases from the feed gas.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

A number of figures show block diagrams of systems and apparatus of embodiments of the invention. A number of figures show flow diagrams illustrating systems and apparatus for such embodiments. The operations of the flow diagrams will be described with references to the systems/apparatuses shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

In an embodiment, rare gases are extracted from atmospheric air or other feed gas using a large centrifuge. The rare gases that could be extracted include xenon, krypton, argon, and neon. In such large centrifuges, a passive cooling system such as a light gas cooling of the desired product (e.g., the adiabatic heating of the mixed gas is reduced by the lower compression ratio and higher concentration of lighter gases like nitrogen) occurs in the early stages to prevent the temperature of the gas from rising as a result of the compression of the gas in the centrifuge. Isothermal centrifugation and compression is desired at this point so that a more efficient separation of the rare gases occurs. In later stages, active cooling, such as a heat exchanger, can be used. In an alternative embodiment, a single stage centrifuge is followed by traditional cryogenic air liquefaction and fractional distillation to separate and extract the rare gases.

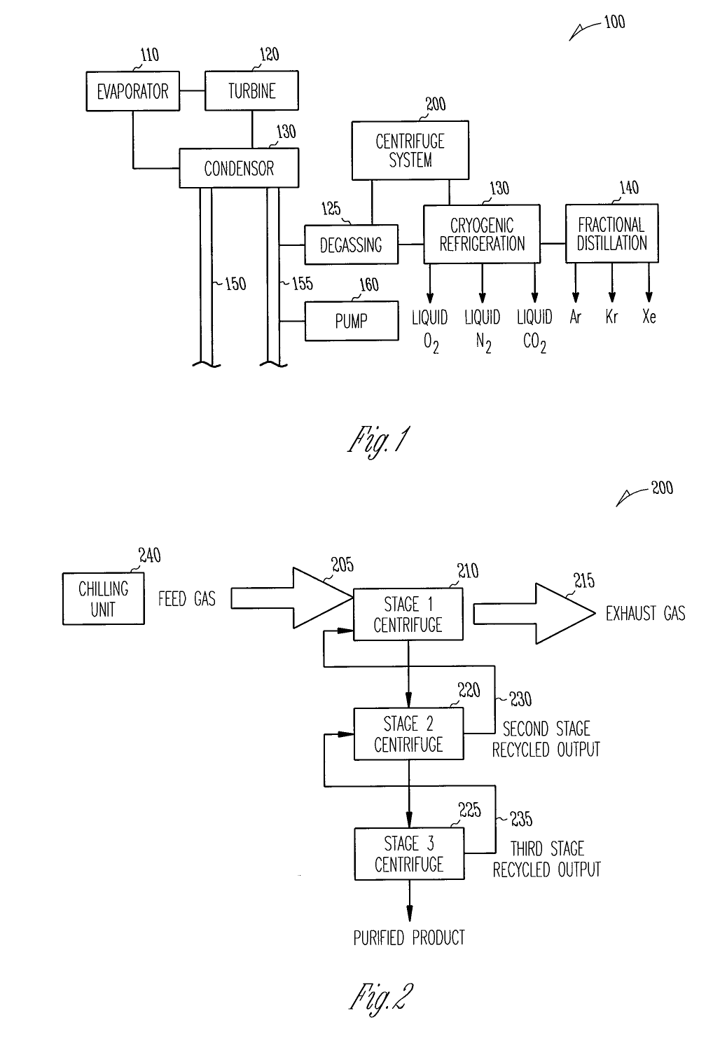

In an embodiment, the feed gas can be received from an Ocean Thermal Energy Conversion (OTEC) system. FIG. 1 illustrates an example embodiment of an Ocean Thermal Energy Conversion (OTEC) system 100 that includes components that can be configured to extract noble (or rare) gases from the ocean or sea water as the case may be. The OTEC system 100 includes an evaporator 110, a turbine 120 coupled to the evaporator, a condenser 130 coupled to the turbine, and a cold water feed pipe 155 and a cold water return pipe 150, both coupled to the condenser 130. As is known in the art, such an OTEC system 100 includes a working fluid such as ammonia, which is heated and vaporized in the evaporator 110 by the warm ocean or sea water. The gaseous ammonia is fed into the turbine 120, and the gaseous ammonia turns the turbine, thereby generating a current flow. The ammonia is condensed in the condenser 130, and the cycle is repeated.

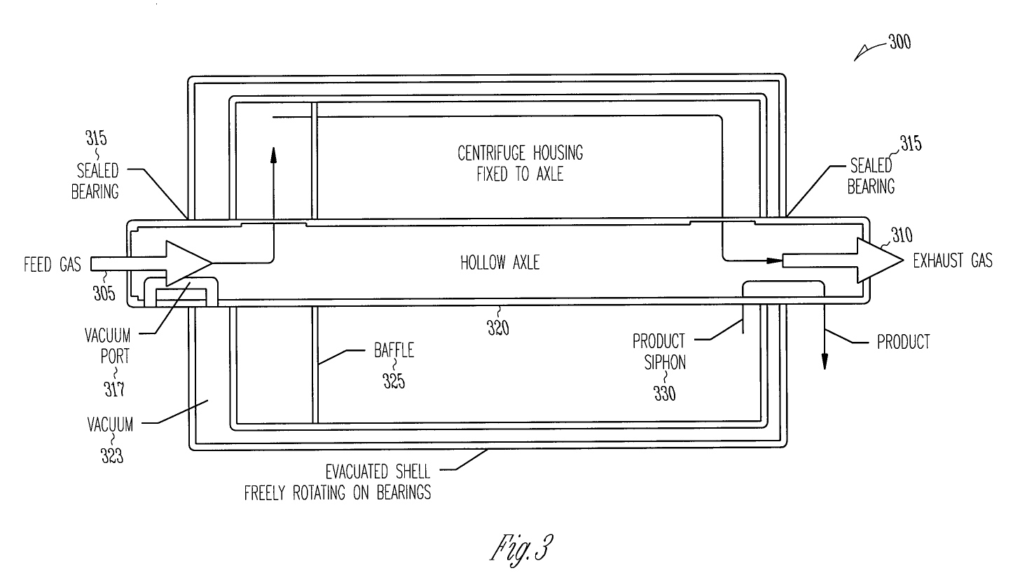

Coupled to this typical OTEC system 100 is a pump 160. In an embodiment, the pump 160 is coupled to the cold water feed pipe 155. A degasser 125 is also coupled to the cold water feed pipe 155, a cryogenic refrigeration unit 130 is coupled to the degasser, and a fractional distillation unit 140 is coupled to the cryogenic refrigeration unit. A centrifuge system, such as the system 200 in FIG. 2, can be coupled to the degasser 125 and the cryogenic refrigeration unit 130. The centrifuge system 200 can be used to extract rare gases as explained in detail herein, and also to capture carbon dioxide. The carbon dioxide has many uses such as a feed stock for liquid fuel, a source for dry ice, and for generally sequestering carbon. In the OTEC system 100, cold ocean or sea water is brought from depths of approximately 1,000 meters to near the ocean surface by the pump 160. This cold ocean water is used as a cold sink in the condenser 130 (or heat exchanger) in the OTEC system to condense the working fluid in the OTEC system. The degasser 125 degasses the cold ocean water by a vacuum and/or a heat source. If the ocean water is degassed by heating, it is preferable to degas the ocean water after it has been used to condense the working fluid in the OTEC system. The gas extracted from the ocean water is then fed into an air liquefaction cryogenic refrigeration unit 130. The cryogenic refrigeration unit generates products such as liquid oxygen, nitrogen, and carbon dioxide. A byproduct of this air liquefaction process is the noble gases, which is then fed into a fractional distillation unit 140 where the noble gases such as argon, krypton and xenon are separated and extracted. Since the concentration of these noble gases is higher in the gases that are dissolved in the ocean water than in atmospheric air, a greater amount of these noble gases is recovered than in prior art processes that use atmospheric air as the source.

In another embodiment, the rare gases can be separated and extracted from atmospheric air or other feed gas using a multiple stage centrifuge. A feed back system can be implemented to monitor the separation and extraction process and accordingly adjust parameters of the process. Simple testing for the desired gases can be done to implement the feedback system. In such multiple stage systems, a much higher separation ratio results due to the larger mass differences (between the rare gases and the other gases in the air). In an embodiment, much lower rotation rates can be used in centrifuges with larger diameters.

In an embodiment, a centrifuge has a two meter diameter and is between 4-6 meters high. The centrifuge rotates at approximately 3600 to 7200 RPM. In a multistage embodiment, there can be up to six or seven stages or more. In another embodiment, centrifugation is followed by cryogenic air liquefaction and fractional distillation to separate and extract the rare gases.

FIG. 2 illustrates a block diagram of an example embodiment of a system 200 for the extraction of rare gases. In the system 200, a gas is fed into a stage 1 centrifuge 210 at inlet 205. A chilling unit 240 can be used to pre-chill the feed gas so as to improve the efficiency of the system. Any exhaust gas is exhausted at outlet 215. Since rare gases have a much higher molecular weight than other gases present in the air such as oxygen, the rare gases such as xenon are easily separated. The fraction enriched in the heavier rare gases is fed into a second stage 220 of the centrifuge. The second stage 220 feeds the heavier gas portion to the third stage 225. A second stage recycled output 230 is returned back to the first stage 210. Similarly, a third stage recycled output 235 is returned to the second stage 220 from the third stage 225. Adiabatic compression increases the number of stages required. However, adiabatic compression is mitigated by light gas cooling in the early stages and heat exchangers in the later stages.

FIG. 3 illustrates a longitudinal cross sectional view of an example centrifuge that can be used in connection with the present disclosure. The centrifuge 300 has a feed gas inlet 305 and an exhaust gas outlet 310. A sealed bearing 315 prevents any atmospheric air from leaking into the vacuum shell, and a vacuum port 317 permits a vacuum to be created in the system. A hollow axle 320 provides a passageway through which the gas to be separated flows. Baffles 325 are attached to the hollow axle. Product siphons 330 can be used to siphon off the product of rare gases. In a centrifuge, the air in the outside portion of the centrifuge causes friction losses. This is mitigated by the vacuum shell 323 in the centrifuge. Turbulence in the system is mitigated by baffles 325 in the system. The baffles 325 control angular velocity by forcing a constant angular velocity.

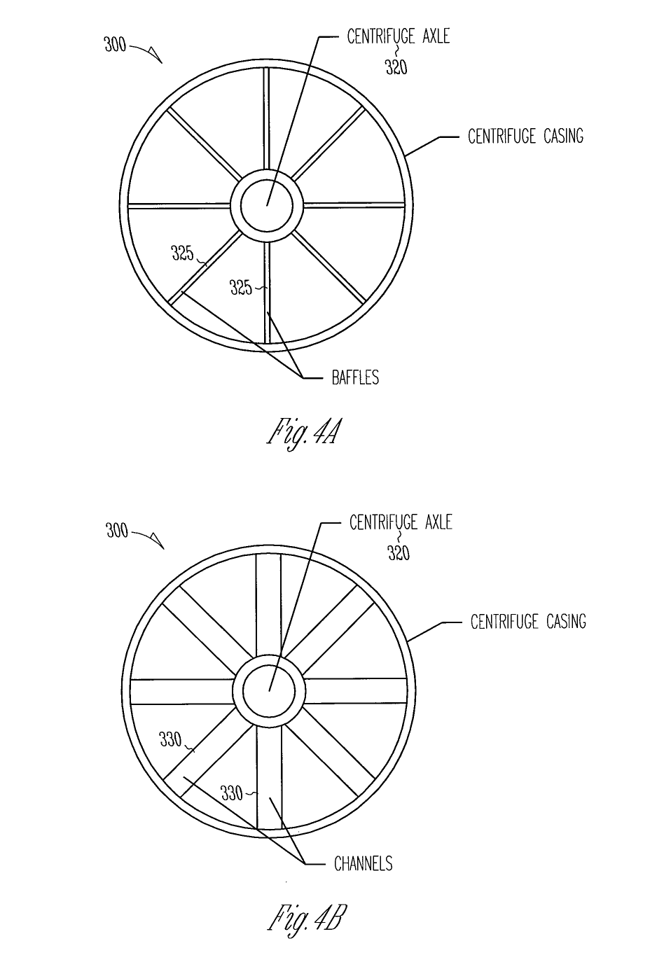

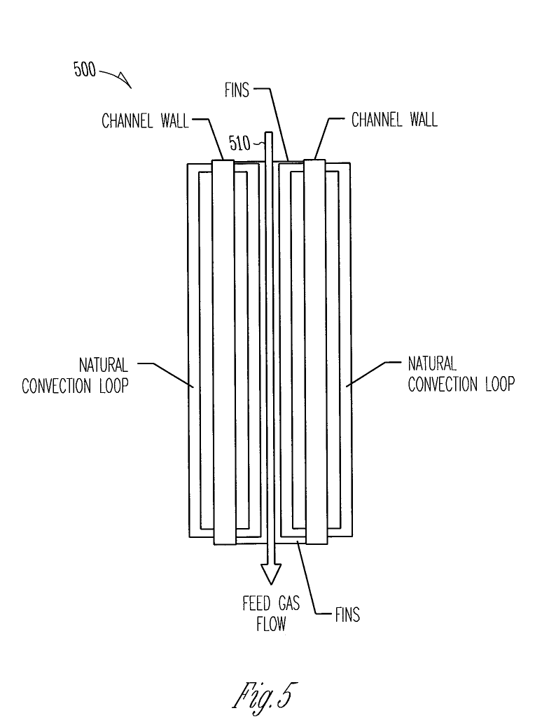

FIG. 4A illustrates an end view of the centrifuge 300 showing the centrifuge axle 320 and the centrifuge baffles 325 attached to the centrifuge axle. The baffles control angular momentum transfer, and the rare gases separate more quickly in the presence of the baffles. The baffles also control the turbulence in the system. In another embodiment illustrated in FIG. 4B, channels 330 are used in place of the baffles.

FIG. 5 illustrates a cross sectional view of a radial heat exchanger 500. A feed gas is fed into a central axle 510. The heat exchanger 500 keeps the process isothermal, since the rare gases would heat up as they are being compressed, and this would inhibit separation. Therefore, with the use of the heat exchanger 500, the rare gases do not heat up as they move to the outside of the centrifuge. The process can also be adiabatic, that is, no energy transfer is allowed to occur in this process (e.g., the heat exchangers may be omitted). The heat exchanger 500 can be integrated with one or more of the centrifuges.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A process to extract one or more rare gases from a feed gas comprising providing the feed gas to a centrifuge.

2. The process of claim 1, comprising:
applying cryogenic air liquefaction to an output of the centrifuge; and
fractionally distilling an output of the cryogenic air liquefaction to separate and extract the one or more rare gases.

3. The process of claim 1, wherein the centrifuge comprises a multistage centrifuge.

4. The process of claim 1, wherein a heat exchanger is integrated into the centrifuge.

5. The process of claim 1, comprising receiving the feed gas from an Ocean Thermal Energy Conversion (OTEC) plant.

6. The process of claim 1, comprising using a feedback from a later stage in the centrifuge to a prior stage in the centrifuge.

7. The process of claim 1, comprising using a light gas cooling of the feed gas.

8. The process of claim 1, comprising chilling the feed gas prior to supplying the feed gas to the centrifuge.

9. A system comprising:
one or more centrifuges configured to receive a feed gas and extract one or more rare gases from the feed gas.

10. The system of claim 9, wherein the system is configured to extract one or more of xenon, argon, and neon.

11. The system of claim 9, comprising a cryogenic air liquefaction unit coupled to an output of the one or more centrifuges, and a fractional distillation unit coupled to an output of the cryogenic air liquefaction unit.

12. The system of claim 9, comprising a heat exchanger coupled to the one or more centrifuges.

13. The system of claim 9, wherein the one or more centrifuges are coupled to an Ocean Thermal Energy Conversion (OTEC) plant.

14. The system of claim 13, wherein the one or more centrifuges are configured to capture carbon dioxide from the OTEC plant.

15. The system of claim 9, comprising a feedback from a later centrifuge in the system to a prior centrifuge in the system.

16. The system of claim 9, comprising one or more of a light gas cooling unit and an active cooling unit coupled to the one or more centrifuges.

17. The system of claim 9, comprising a vacuum shell surrounding the one or more centrifuges.

18. The system of claim 9, comprising a heat exchanger coupled to the one or more centrifuges to chill the feed gas.

19. The system of claim 9, wherein the one or more centrifuges comprise a plurality of baffles or a plurality of channels.

20. A system comprising:
one or more centrifuges configured to receive a feed gas and extract one or more rare gases from the feed gas;
a cryogenic air liquefaction unit coupled to an output of the one or more centrifuges; and
a fractional distillation unit coupled to an output of the cryogenic air liquefaction unit.
